(19) United States
(12) Patent Application Publication
(10) Pub. No.: US 2024/0347039 A1
(43) Pub. Date: Oct. 17, 2024

(54) SPEECH SYNTHESIS APPARATUS, SPEECH SYNTHESIS METHOD, AND SPEECH SYNTHESIS PROGRAM

(71) Applicants: NIPPON TELEGRAPH AND TELEPHONE CORPORATION, Tokyo (JP); The University of Tokyo, Tokyo (JP)

(72) Inventors: Yusuke IJIMA, Musashino-shi, Tokyo (JP); Tomoki KORIYAMA, Tokyo (JP); Shinnosuke TAKAMICHI, Tokyo (JP)

(73) Assignees: NIPPON TELEGRAPH AND TELEPHONE CORPORATION, Tokyo (JP); The University of Tokyo, Tokyo (JP)

(21) Appl. No.: 18/683,786

(22) PCT Filed: Aug. 18, 2022
(86) PCT No.: PCT/JP2022/031276

§ 371 Date: Feb. 15, 2024

(30) Foreign Application Priority Data
Aug. 18, 2021 (JP) 2021-133713

(51) Int. Cl. G10L 13/08

(52) U.S. Cl. CPC G10L 13/08

(57) ABSTRACT

A speech synthesis apparatus according to the present disclosure includes a memory and a processor coupled to the memory. The processor is configured to: obtain utterance information on subjects to be uttered, wherein the subjects to be uttered are texts contained in data on a book, obtain image information on images that are contained in the data on the book, obtain speech data corresponding to the subjects to be uttered; and generate, based on the obtained utterance information, the obtained image information, and the obtained speech data, a speech synthesis model for reading out a text associated with an image.

### TECHNICAL FIELD

The present disclosure relates to a speech synthesis apparatus, a speech synthesis method, and a speech synthesis program.

### BACKGROUND ART

Speech synthesis techniques based on deep neural networks (DNNs), have been proposed in recent years in the field of speech synthesis. It has been known that speech synthesis techniques based on DNNs can generate synthesized speech that is of higher quality than the synthesized speech obtained by conventional techniques (See the following Non-Patent Literature).

### CITATION LIST

### Non Patent Literature

Non Patent Literature 1: Zen, Heiga, Andrew Senior, and Mike Schuster. “STATISTICAL PARAMETRIC SPEECH SYNTHESIS USING DEEP NEURAL NETWORKS.” Acoustics, Speech and Signal Processing (ICASSP), 2013 IEEE International Conference on. IEEE, 2013.
Non Patent Literature 2: Shen, Jonathan, et al. “NATURAL TTS SYNTHESIS BY CONDITIONING WAVENET ON MEL SPECTROGRAM PREDICTIONS.” 2018 IEEE International Conference on Acoustics, Speech and Signal Processing (ICASSP). IEEE, 2018.

### SUMMARY OF INVENTION

### Technical Problem

However, the above prior art may have difficulty in reading out a book containing images in natural synthesized speech.

For example, a book containing images is a picture book. Compared to reading-out speech that is provided by a narrator who reads out a picture book, the aforementioned prior art has a difference in naturalness, such as cadences. The factor of the difference includes the fact that the prior art generates synthesized speech from linguistic information, such as reading and accents, obtained from text of the picture book.

When a narrator reads out a book, the narrator vocalizes using not only linguistic information but also various sets of information, such as visual information obtained from illustration (for example, description of characters and the background) and feelings of the characters that can be estimated from the long-term context.

Therefore, the disclosure proposes a speech synthesis apparatus capable of reading out a book containing images in natural synthesized speech, a speech synthesis method, and a speech synthesis program.

### Solution to Problem

In one aspect of the present disclosure, a speech synthesis apparatus includes: an obtainer that obtains utterance information on a subject to be uttered that is text contained in a first book, image information on an image that is contained in the first book, and speech data corresponding to the subject to be uttered; and a generator that, based on the utterance information, the image information, and the speech data that are obtained by the obtainer, generates a speech synthesis model for reading out a second book that contains text that is associated with an image.

### Advantageous Effects of Invention

A speech synthesis apparatus according to one or a plurality of embodiments of the disclosure is capable of reading out a book containing images in natural synthesized speech.

### BRIEF DESCRIPTION OF DRAWINGS

FIG. 1 is a block diagram of an example of an environment for speech synthesis.

FIG. 2 illustrates an example of a structure of a speech synthesis model according to the disclosure.

FIG. 3A illustrates an overview of the speech synthesis process according to the disclosure.

FIG. 3B illustrates the overview of the speech synthesis process according to the disclosure.

FIG. 3C illustrates the overview of the speech synthesis process according to the disclosure.

FIG. 3D illustrates the overview of the speech synthesis process according to the disclosure.

FIG. 4 is a block diagram of an example of a configuration of a speech synthesis apparatus according to the disclosure.

FIG. 5 illustrates an example of utterance information according to the disclosure.

FIG. 6 illustrates an example of book information according to the disclosure.

FIG. 7 illustrates an example of training of the speech synthesis model according to the disclosure.

FIG. 8 illustrates an example of speech synthesis according to the disclosure.

FIG. 9 is a flowchart illustrating an example of a process for generating the speech synthesis model.

FIG. 10 illustrates an example of a hardware configuration of a computer.

### DESCRIPTION OF EMBODIMENTS

A plurality of embodiments will be described below in detail with reference to the drawings. Note that the present invention is not limited by the embodiments. A plurality of features of various embodiments can be combined in various ways under the condition that the features are not inconsistent. The same elements are denoted with the same reference numerals and redundant description will be omitted.

### 1. Environment for Speech Synthesis

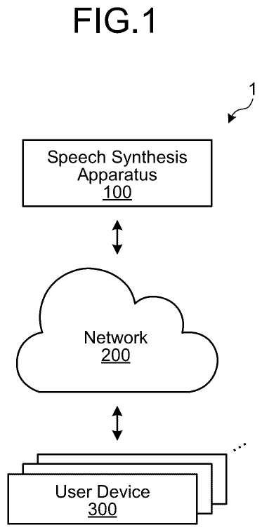

First of all, an environment for speech synthesis according to the disclosure will be described with reference to FIG. 1.

FIG. 1 is a block diagram of an environment 1 that is an example of the environment for speech synthesis. As illustrated in FIG. 1, the environment 1 includes a speech synthesis apparatus 100, a network 200, and a user device 300.

The speech synthesis apparatus 100 is an apparatus that performs one or a plurality of speech synthesis processes. One or more speech synthesis processes include a process of generating a speech synthesis model and a process of generating a synthesized speech using the generated speech synthesis model. The overview of the speech synthesis process according to the disclosure will be described in the following section.

The speech synthesis apparatus 100 is a data processing apparatus, such as a server. An example of a configuration of the speech synthesis apparatus 100 will be described in the fourth section.

The network 200 is, for example, a network, such as a LAN (Local Area Network), a WAN (Wide Area Network), or the Internet. The network 200 connects the speech synthesis apparatus 100 and the user device 300.

The user device 300 is a data processing device, such as a client device. When the user wants to have a speech synthesis model, the user device 300 provides training data for a speech synthesis model to the speech synthesis apparatus 100. Thereafter, the generated speech synthesis model is provided from the speech synthesis apparatus 100 to the user device 300.

When the user wants to turn the book (for example, an electronic book) into an audio book, the user provides data on the book to the speech synthesis apparatus 100. In this case, a synthesized speech reading the book is provided from the speech synthesis apparatus 100 to the user device 300.

### 2. Structure of Speech Synthesis Model

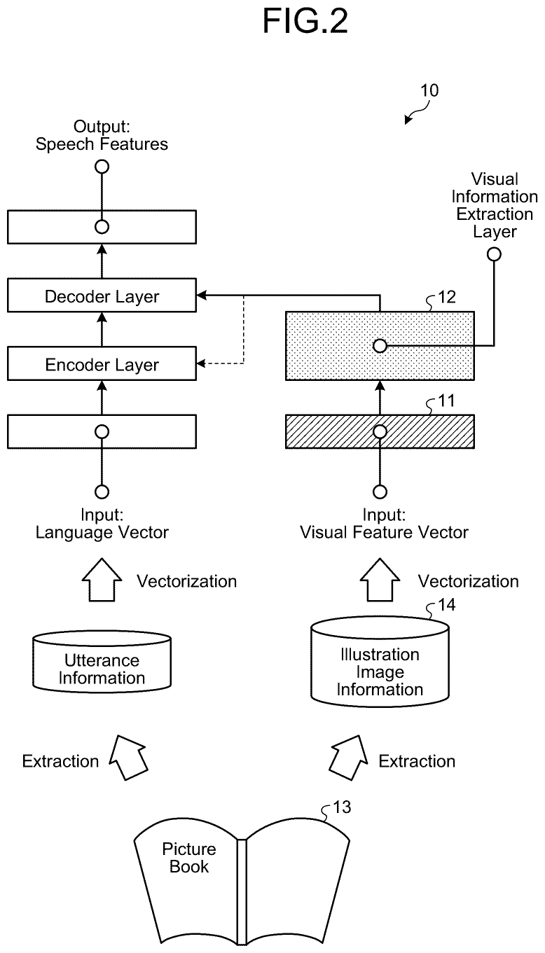

Next, an example of a structure of the speech synthesis model according to the disclosure will be described next with reference to FIG. 2.

FIG. 2 illustrates a model structure 10 that is an example of a model structure of the speech synthesis model according to the disclosure. The speech synthesis model according to the disclosure, for example, is implemented by a neural network. The model structure 10 is illustrated as a neural network configuration for speech synthesis according to the disclosure.

Neural networks have been used for implementing speech synthesis models. A conventional neural network for speech synthesis has one input and the one input is a language vector obtained from text information that is contained in a book (See Non-Patent Literature 2).

On the contrary to that, the model structure 10 in FIG. 2 has two inputs. An input layer 11 and a visual information extraction layer 12 are a significant difference between a conventional neural network configuration for speech synthesis and a neural network configuration for speech synthesis according to the disclosure.

A first input of the model structure 10 is a language vector similarly as in the case of the conventional neural network configuration for speech synthesis. In the example in FIG. 2, the language vector is obtained by vectorizing utterance information that is extracted from a picture book 13. The utterance information is information to be uttered. A subject to be uttered in the picture book 13 is a sentence contained in the picture book 13.

A second input of the model structure is a visual feature vector that is not in the conventional neural network configuration for the speech synthesis. In the example in FIG. 2, the visual feature vector is obtained by vectorizing illustration image information 14 that is extracted from the picture book 13. The illustration image information 14 is information on an image of illustration. The image of the illustration in the picture book 13 is a picture that is contained in the picture book 13.

An output of the visual information extraction layer 12 is input to, for example, a decoder layer (the arrow in a solid line). The output of the visual information extraction layer 12 may be input to an encoder layer depending on implementation of a neural network (the arrow in a dashed line).

### 3. Overview of Speech Synthesis Process

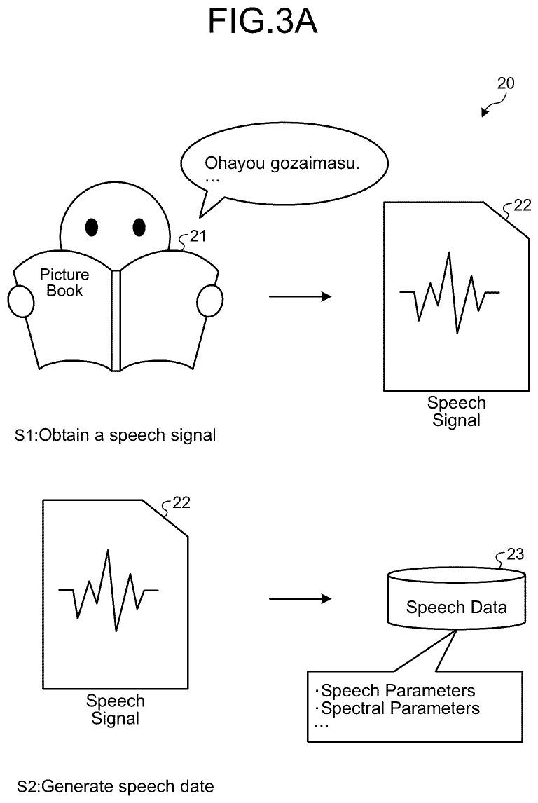

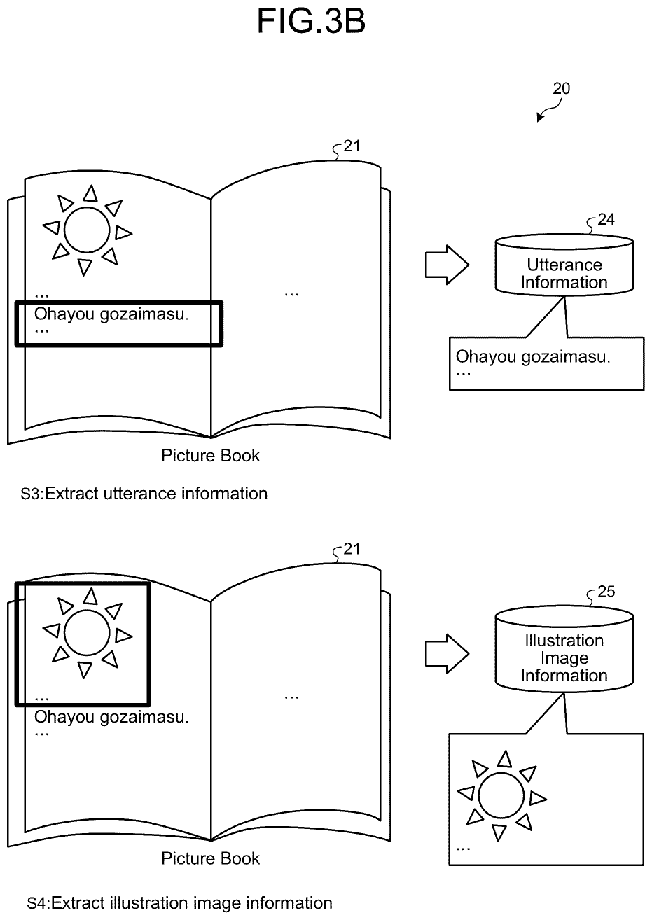

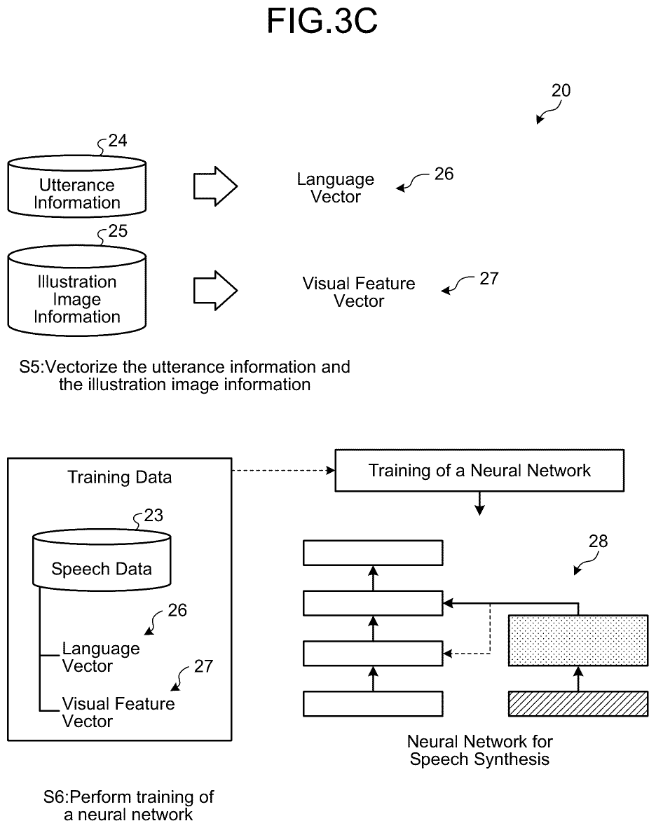

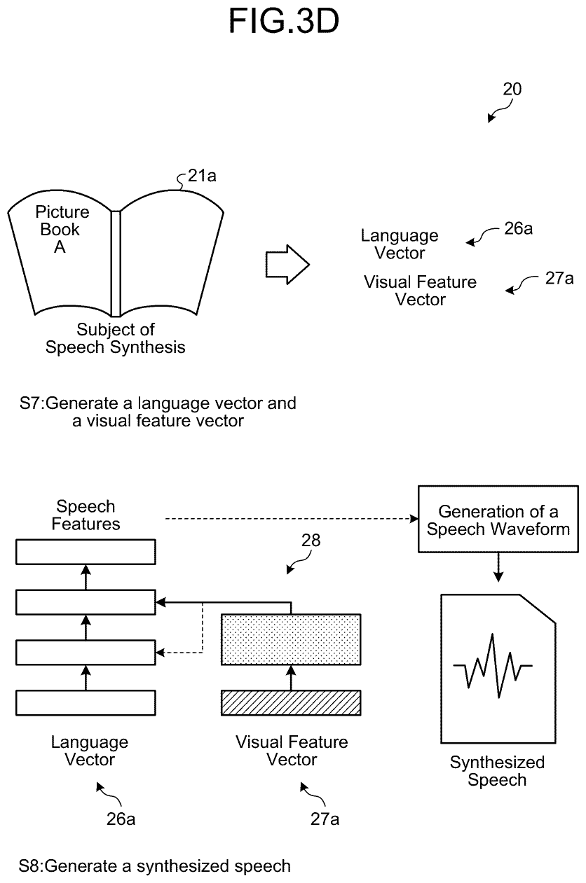

With reference to FIG. 3A, FIG. 3B, FIG. 3C and FIG. 3D, the overview of the speech synthesis process according to the disclosure will be described next. The speech synthesis process described in the present section contains a process of generating a neural network for speech synthesis and the neural network includes the model structure 10 described above with reference to FIG. 2. The overview is not intended to limit the present invention and a plurality of embodiments described in the following section.

FIG. 3A, FIG. 3B, FIG. 3C and FIG. 3D collectively illustrate an overview 20 of the speech synthesis process according to the disclosure.

With reference to FIG. 3A, at step S1, the speech synthesis apparatus 100 in FIG. 1 obtains a speech signal 22 of reading out a picture book 21.

At step S2, the speech synthesis apparatus 100 generates speech data 23 from the speech signal 22. The speech data 23 contains speech parameters (for example, a basic frequency) of the speech signal 22 and spectral parameters (for example, a mel spectrogram).

According to FIG. 3B, at step S3, the speech synthesis apparatus 100 extracts utterance information 24 from the picture book 21. In the example in FIG. 3B, a page of the picture book 21 contains the sentence of “Good morning.” Thus, the utterance information 24 contains a character string of “Good morning.”.

At step S4, the speech synthesis apparatus 100 extracts illustration image information 25 from the picture book 21. In the example in FIG. 3B, the page containing the above-described sentence contains a picture of the sun. Thus, the illustration image information 25 contains an image of the sun.

According to FIG. 3C, at step S5, the speech synthesis apparatus 100 vectorize the utterance information 24 and the illustration image information 25. In the example in FIG. 3C, the speech synthesis apparatus 100 converts the utterance information 24 into a language vector 26. The speech synthesis apparatus 100 converts the illustration image information 25 into a visual feature vector 27.

At step S6, the speech synthesis apparatus 100 trains the neural network for speech synthesis. The speech synthesis apparatus 100 uses the language vector 26 and the visual feature vector 27 that are obtained at step S5 as an of the training data. The speech synthesis apparatus 100 uses the speech data 23 that is obtained at step S2 as an output of the training data. As a result, the speech synthesis apparatus 100 generates a speech synthesis model 28.

With reference to FIG. 3D, at step S7, the speech synthesis apparatus 100 generates a language vector 26a and a visual feature vector 27a from a picture book 21a that is a subject of speech synthesis. The picture book 21a is an unknown picture book different from the picture book 21.

At step S8, the speech synthesis apparatus 100 generates a synthesized speech of reading the picture book 21a. First of all, the speech synthesis apparatus 100 inputs the language vector 26a and the visual feature vector 27a to the speech synthesis model 28 and obtains speech features. The speech synthesis apparatus 100 generates a speech waveform from the speech features, thereby generating a synthesized speech.

As described above, the speech synthesis apparatus 100 utilizes the illustration image information 25 in speech synthesis on a book, such as a picture book. The conventional speech synthesis technique uses linguistic information, such as reading and accents, as an input of a neural network for speech synthesis. On the other hand, the speech synthesis apparatus 100 utilizes also visual information that is obtained from a book, such as a picture book, as an input of a neural network for speech synthesis. For this reason, the speech synthesis apparatus 100 is able to generate a synthesized speech in consideration of information contained in illustration.

### Configuration of Speech Synthesis Apparatus

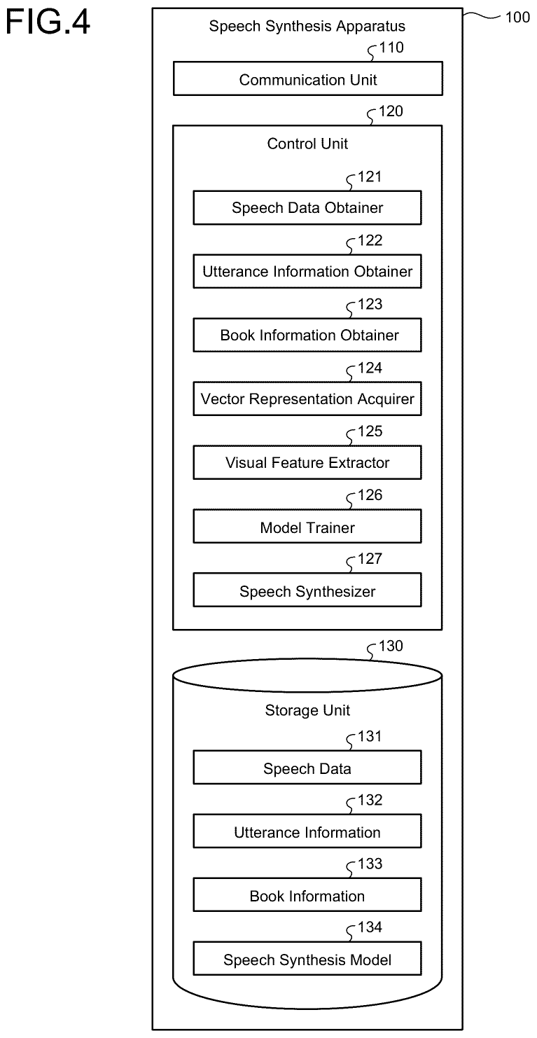

With reference to FIG. 4, an example of a configuration of the speech synthesis apparatus 100 will be described next.

FIG. 4 is a block diagram of the speech synthesis apparatus 100 that is an example of the configuration of the speech synthesis apparatus according to the disclosure. As illustrated in FIG. 4, the speech synthesis apparatus 100 includes a communication unit 110, a control unit 120, and a storage unit 130. The speech synthesis apparatus 100 may include an input unit (for example, a keyboard or a mouse) that receives an input from a manager of the speech synthesis apparatus 100. The speech synthesis apparatus 100 may include an output unit (for example, a liquid crystal display, an organic electro luminescence (EL) display) that displays information to the manager of the speech synthesis apparatus 100.

### 4-1. Communication Unit 110

The communication unit 110 is implemented, for example, using a network interface card (NIC). The communication unit 110 is connected with the network 200 in a wired or wireless manner. The communication unit 110 is able to transmit and receive information to and from the user device 300 via the network 200.

### 4-2. Control Unit 120

The control unit 120 is a controller. The control unit 120 uses a RAM (Random Access Memory) as a work area and is implemented using one or a plurality of processors (for example, a CPU (Central Processing Unit) or a MPU (Micro Processing Unit)) that execute various types of programs that are stored in a storage device of the speech synthesis apparatus 100. The control unit 120 may be implemented using an integrated circuit, such as an ASIC (Application Specific Integrated Circuit), a FPGA (Field Programmable Gate Array), a GPGPU (General Purpose Graphic Processing Unit).

As illustrated in FIG. 4, the control unit 120 includes a speech data obtainer 121, an utterance information obtainer 122, a book information obtainer 123, a vector representation acquirer 124, a visual feature extractor 125, a model trainer 126, and a speech synthesizer 127. One or a plurality of processors of the speech synthesis apparatus 100 execute instructions that are stored in one or a plurality of memories of the speech synthesis apparatus 100, thereby implementing each control unit. Data processing that is performed by each control unit is an example and each control unit (for example, a model trainer) may perform data processing that is described in association with another control unit (for example, a model trainer).

The speech data obtainer 121, the utterance information obtainer 122, and the book information obtainer 123 are a plurality of examples of an “obtainer”. The vector representation acquirer 124 is an example of a “first converter”. The visual feature extractor 125 is an example of a “second converter”. The model trainer 126 is an example of a “generation unit”.

### 4-2-1. Speech Data Obtainer 121

The Speech Data Obtainer 121 obtains speech data corresponding to a subject to be uttered in a book. The subject to be uttered is text contained in the book. A picture book or a picture story is taken as an example of the book. For example, the subject to be uttered is text contained in a specific page of the book. The text is associated with an image that is contained in the specific page.

The speech data contains speech that is recorded previously to be used to train the speech synthesis model. The speech data has speech including utterance of a narrator who reads text contained in book information to be described below (that is, text contained in the book). The speech data is obtained by performing signal processing on a speech signal that is let out by the narrator. The speech data has speech parameters (for example, a high-tone parameter, such as a basic frequency) and a spectrum parameter (for example, the mel-spectrogram, the cepstrum, or the mel-cepstrum).

The speech data obtainer 121 is able to receive speech data from the user device 300. The speech data obtainer 121 is able to store the received speech data in the storage unit 130. The speech data obtainer 121 is able to obtain the speech data from the storage unit 130.

### 4-2-2. Utterance Information Obtainer 122

The utterance information obtainer 122 obtains utterance information on a subject to be uttered. The utterance information corresponds to the speech data that is obtained by the speech data obtainer 121. The utterance information contains text information that is contained in the book information to be described below. The text information represents text contained in the book.

As described below, the utterance information can contain information presenting accents, parts of speech, and a time of start of a phonome or a time of end of a phonome of the subject to be uttered.

The utterance information contains information on pronunciation that is given to each utterance in the speech data. The speech information is given to each utterance in the speech data that is obtained by the speech data obtainer 121. The utterance information can contain at least the text information that is contained in the book information to be described below.

The utterance information that is given to the speech data can contain information other than the text information. For example, the utterance information may contain accent information (an accent type or an accent phase length), part-of-speech information, and information on a time of start of each phonome or a time of end of each phonome (phonome segmentation information). The start time and the end time are a tune of elapse in the case where a start point of each utterance is 0 (second).

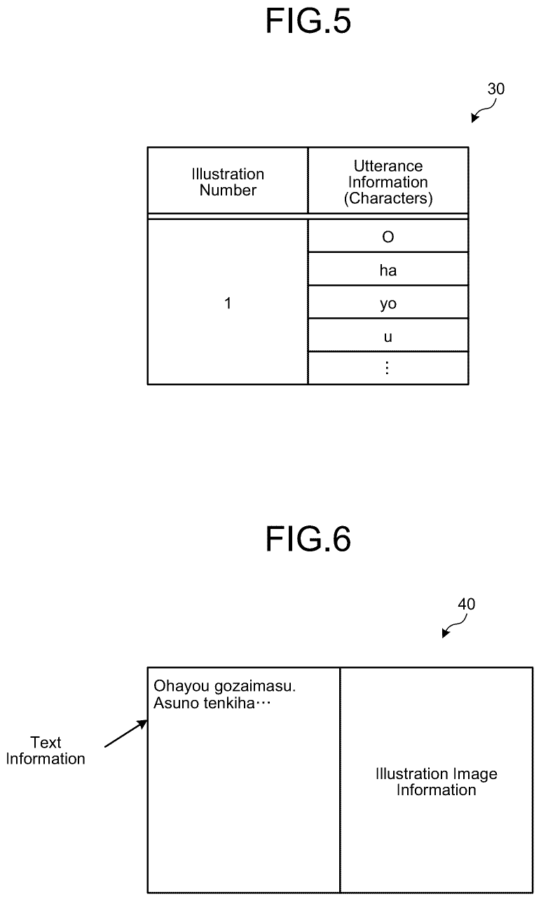

FIG. 5 illustrates utterance information 30 that is an example of the utterance information according to the disclosure. As illustrated in FIG. 5, the utterance information 30 contains a character string of “Ohayou”. An illustration number that is contained in the book information to be described below is given to each utterance. In the example in FIG. 5, an utterance of “O”, an utterance of “HA”, an utterance of “YO”, and an utterance of “U” correspond to an illustration number “1”. Each utterance is associated with the corresponding illustration number.

The illustration number is contained in the book information to be described below and represents correspondence between the utterance information and the illustration. A unique ID (identifier), such as a number, is given to each illustration.

Back to FIG. 4, the utterance information obtainer 122 is able to receive the utterance information from the user device 300. The utterance information obtainer 122 is able to store the received utterance information in the storage unit 130. The utterance information obtainer 122 is able to obtain the utterance information from the storage unit 130.

### 4-2-3. Book Information Obtainer 123

The book information obtainer 123 obtains various types of information on the book. The book information contains text contained in the book. The book information contains image information on the image contained in the book.

FIG. 6 illustrates book information 40 that is an example of the book information according to the disclosure. As illustrated in FIG. 5, text information and illustration image information are contained. The text information can be information that is required to generate the speech data described above. The text information, for example, presents a character string that is a subject to be uttered in a picture book or a picture story. The illustration image information contains an image of an illustration corresponding to the text information.

Back to FIG. 4, the book information obtainer 123 is able to receive the book information from the user device 300. The book information obtainer 123 is able to store the received book information in the storage unit 130. The book information obtainer 123 is able to obtain the book information from the storage unit 130.

### 4-2-4. Vector Representation Acquirer

The vector representation acquirer 124 convers the utterance information into a linguistic vector presenting linguistic information of the subject to be uttered. The vector representation acquirer 124 acquires a linguistic vector by converting the utterance information into an expression (a numerical expression) that is usable in the model trainer 126 to be described below.

When information (characters) of the text is used as utterance information, a one-hot expression is used for conversion of the utterance information into a linguistic vector. The number of dimensions of the vector of the one-hot expression is a number N of characters contained in the utterance information. The value of the dimension corresponding to input characters is “1”, the value of a dimension not corresponding to input characters is “0”. In an example, when the value of a first dimension is “1” and the value of a dimension other than the first dimension is “0”, the vector of the one-hot expression may correspond to a character of “A”. Similarly, when the value of a second dimension is “1” and the values of the dimensions other than the second dimension are “0”, the vector of a one-hot expression may correspond to a character “I”.

When a phonome and accents are used as the utterance information, the vector representation acquirer 124 converts the phonome and the accents into a numerical vector as in the case of Non-Patent Literature 1. When the characters are used as the utterance information, the vector representation acquirer 124 applies text analysis to the utterance information. The vector representation acquirer 124 is able to use the phonome and the accent information that are obtained from text analysis. For this reason, the vector representation acquirer 124 is able to convert the phonome and the accents into a numerical vector using the same method as that of Non-Patent Literature 1 described above.

### 4-2-5. Visual Feature Extractor 125

The visual feature extractor 125 is able to extract visual features from the illustration image information that is contained in the book information. The visual feature extractor 125 converts the image information into a visual feature vector representing visual features of the image that is contained in the book. For example, the visual feature extractor 125 acquires a visual feature vector by converting the illustration image information contained in the book information into a vector expression that is usable by the model trainer 126 to be described below.

The visual feature extractor 125 outputs a visual feature vector that is used as the input of the neural network for speech synthesis from the illustration image information.

A neural network for identifying an image that is trained previously from a large volume of image data is used for conversion from the illustration image information into a visual feature vector. When the illustration image information is converted into a visual feature vector, the visual feature extractor 125 executes a forward propagation process from the illustration image information that is input to the neural network (See “Hu, Jie, Li Shen, and Gang Sun. “Squeeze-and-Excitation Networks.” Proceedings of the IEEE conference on computer vision and pattern recognition. 2018.”).

The visual feature extractor 125 acquires information on an output layer eventually and outputs the information on the output layer as a visual feature vector.

The visual feature information vector that is output may be information other that the information on the output layer. The visual feature extractor 125 may use an output of an intermediate layer (Bottleneck layer) as the visual feature information vector. By using such a neural network for image identification that is trained previously, the visual feature extractor 125 is able to acquire a vector that reflects information on a character or the background that is contained in the illustration image information.

### 4-2-6. Model Trainer 126

The model trainer 126 generates the speech synthesis model based on the utterance information that is obtained by the utterance information obtainer 122, the image information that is obtained by the book information obtainer 123, and the speech data that is obtained by the speech data obtainer 121. In order to generate the speech synthesis model, the model trainer 126 uses training data that contains the speech data that is associated with the language vector and the visual feature vector.

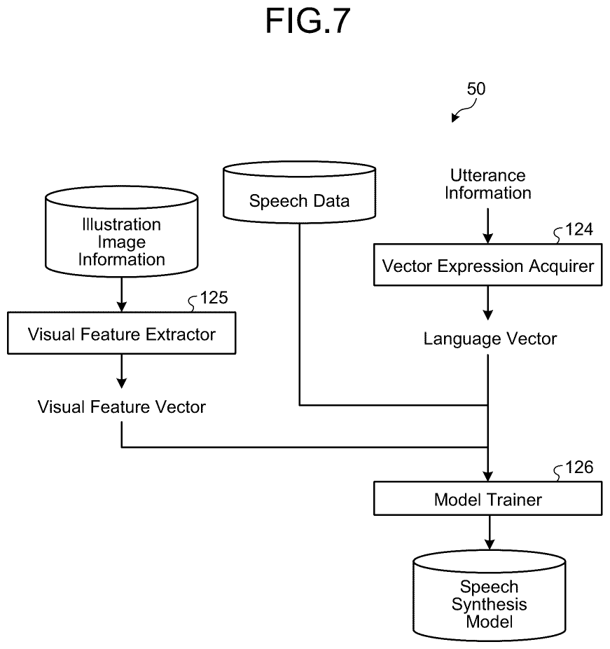

FIG. 7 illustrates learning 50 that is an example of training of the speech synthesis model according to the disclosure. In the training 50, the model trainer 126 trains the speech synthesis model (for example, the neural network for speech synthesis) using the speech data, the utterance information, and the illustration image information contained in the book information. The learning 50 illustrates a flow of various types of data that are used to train the speech synthesis model.

As illustrated in FIG. 7, the model trainer 126 trains the neural network for speech synthesis that estimates the speech parameters from the linguistic vector and the visual feature vector, using the speech data, the linguistic vector that is acquired by the vector representation acquirer 124, and the visual feature vector that is acquired by the visual feature extractor 125. The model trainer 126 is able to use a training algorithm similar to that according to Non-Patent Literature 2.

The model trainer 126 is able to use various neural network structures. For example, the model trainer 126 is able to use neural networks of not only a normal MLP (Multilayer Perceptron) but also a RNN (Recurrent Neural Network). a RMM-LSTM (Long Short Term Memory), a CNN (Convolutional Neural Network), and a Transformer and combinations thereof.

Back to FIG. 4, the model trainer 126 is able to store the generated speech synthesis model in the storage unit 130.

As described above, the model trainer 126 uses the visual feature vector that is obtained by the visual feature extractor 125 in addition to the language vector that is used in the conventional neural network for speech synthesis. The visual information vector is obtained from the illustration image information that is extracted from a book, such as a picture book. As a result, the model trainer 126 is able to train the neural network for speech synthesis in consideration of information of the looking and expression of the character or the background (for example, the scenery, the weather, etc.) contained in the illustration image information. The speech synthesis model that is generated by the model trainer 126 enables generation of a synthesized speech with natural cadence.

### 4-2-7. Speech Synthesizer 127

Back to FIG. 4, the speech synthesizer 127 generates a synthesized speech using the speech synthesis model that is generated by the model trainer 126.

For example, the speech synthesizer 127 obtains the speech synthesis model from the storage unit 130. The speech synthesizer 127 acquires the language vector and the visual feature vector from an unknown book. The speech synthesizer 127 then inputs the language vector and the visual feature vector that are acquired to the speech synthesis model and obtains speech features. The speech synthesizer 127 generates a synthesized speech by generating a speech waveform from the obtained speech features.

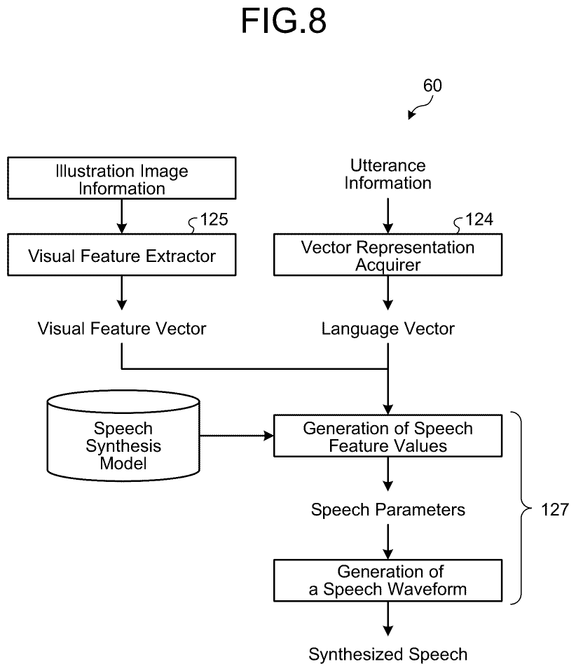

FIG. 8 illustrates speech synthesis 60 that is an example of the speech synthesis according to the disclosure. The speech synthesizer 127 generates a synthesized speech from text that is contained in a picture book or a picture story that are subjects of speech synthesis and the illustration image information corresponding to the picture book or the picture story. The difference between the speech synthesis 60 and the algorithm according to Non-Patent Literature 2 is in that the speech synthesizer 127 uses a visual feature vector that is information other than the language vector as the input of the speech synthesis model. The visual feature vector is acquired from the visual feature extractor 125. The speech synthesis 60 illustrates a flow of various types of data that are used to generate synthesized speech.

As illustrated in FIG. 8, the speech synthesizer 127 applies text analysis to the input text and acquires information corresponding to the utterance information. The vector representation acquirer 124 converts the acquired utterance information into the language vector. The visual feature extractor 125 converts the illustration image information corresponding to the input text into the visual feature vector. The speech synthesizer 127 inputs the language vector and the visual feature vector to the speech synthesis model that is generated by the model trainer 126. The speech features are output by forward propagation. The speech synthesizer 127 generates a speech waveform from the sound feature value, thereby acquiring a synthesized speech.

Prior to generation of a speech waveform, the speech synthesizer 127 may obtain speech parameters group that is smoothed in a time direction, using a MLPG (Maximum Likelihood Generation) algorithm (See “Masuko, et al., “Speech Synthesis based on HMM using Dynamic Features”), Shingakuron, vol. J79-D-II, no. 12, pp. 2184-2190, December 1996”. In order to generate a speech waveform, the speech synthesizer 127 may use a method of generating a speech waveform by signal processing (See “Imai, et al., “Mel-Log Spectrum Approximation (MLSA) filter for Speech Synthesis” and EICE Transactions on Communications A Vol. J66-A No. 2 pp. 122-129, February 1983.). The speech synthesizer 127 may use a method of generating a speech waveform using a neural network (See “Oord, Aaron van den, et al. “WAVENET: A GENERATIVE MODEL FOR RAW AUDIO.” arXiv preprint arXiv:1609.03499 (2016)”).

### 4-3. Storage Unit 130

Back to FIG. 4, the storage unit 130, for example, is implemented using a semiconductor memory device, such as a RAM or a flash memory, or a storage device, such as a hard disk or an optical disk. The storage unit 130 contains speech data 131, utterance information 132, book information 133, and a speech synthesis model 134. The speech data 131 is, for example, speech data that is obtained by the speech data obtainer 121. The utterance information 132 is utterance information that is obtained by the utterance information obtainer 122. The book information 133 is book information that is obtained by the book information obtainer 123. The speech synthesis model 134 is, for example, a speech synthesis model that is generated by the model trainer 126.

### 5. Flowchart of Speech Synthesis Process

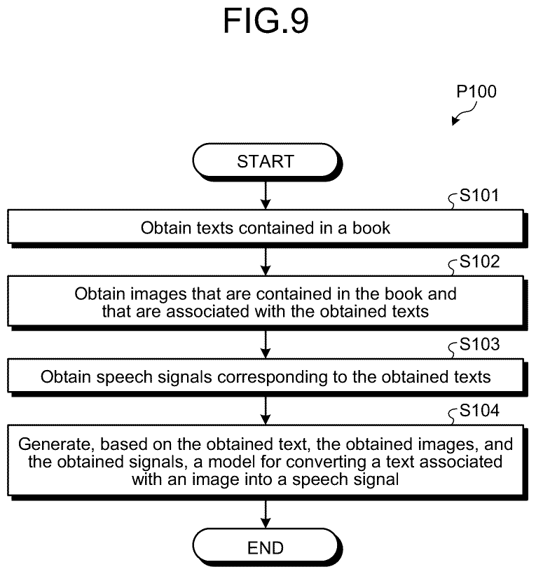

With reference to FIG. 9, a flowchart of an example of the speech synthesis process according to the disclosure will be described next. The example of the speech synthesis process contains a process for generating a speech synthesis model. The process for generating a speech synthesis model, for example, is performed by the speech synthesis apparatus 100 in FIG. 1.

FIG. 9 is a flowchart illustrating a process P100 that is an example of the process for generating a speech synthesis model.

As illustrated in FIG. 9, first of all, the utterance information obtainer 122 of the speech synthesis apparatus 100 obtains texts that are contained in a book (step S101).

The book information obtainer 123 of the speech synthesis apparatus 100 obtains images that are contained in the book and that are associated with the obtained texts (step S102).

The speech data obtainer 121 of the speech synthesis apparatus 100 obtains speech signals corresponding to the texts obtained by the utterance information obtainer 122 (step S103).

Based on the texts obtained by the utterance information obtainer 122, the images obtained by the book information obtainer 123, and the speech signals obtained by the speech data obtainer 121, the model trainer 126 of the speech synthesis apparatus 100 generates a model for converting a text that is associated with an image into a speech signal (step S104). For example, the generated model enables conversion of the text that is associated with the image into speech features. The speech synthesizer 127 of the speech synthesis apparatus 100 is able to convert the generated speech features into a speech signal.

### 6. Effect

As described above, the speech synthesis apparatus 100 utilizes not only linguistic information that is obtained from text in reading of a book, such as a picture book, but also visual information that is obtained from illustration of the book. As a result, the speech synthesis apparatus 100 is able to generate synthesized speech of naturally reading the book, such as a picture book.

### 7. Others

Part of the processes that are described as processes performed automatically can be performed manually. Alternatively, all or part of the processes that are described as processes performed manually can be performed automatically by known methods. Furthermore, the process procedures, the specific names, and the information including various types of data and parameters that are presented in the description and the drawings are changeable freely unless otherwise noted. For example, the various types of information illustrated in each drawing are not limited to the information illustrated in the drawing.

The components of the apparatus illustrated in the drawings conceptually represent the functions of the apparatus. The components are not necessarily be configured physically as illustrated in the drawings. In other words, specific modes of the apparatus that is distributed or integrated are not limited to the modes of the system and the apparatus illustrated in the drawings. All or part of the apparatus can be distributed or integrated functionally or physically according to various types of load and usage.

### 8. Hardware Configuration

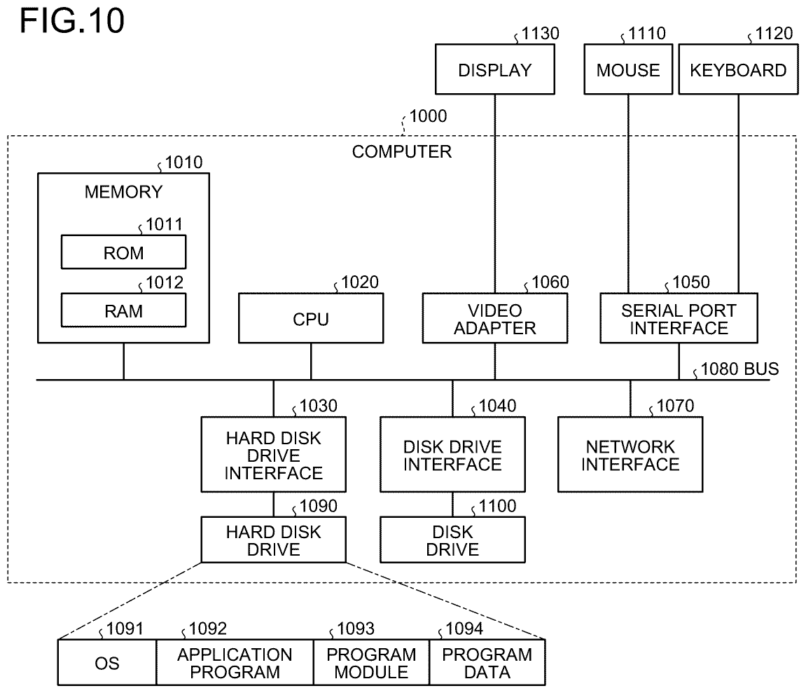

FIG. 10 is a diagram illustrating a computer 1000 that is an example of a hardware configuration of a computer. The system and the method illustrated in the description, for example, are implemented by the computer 1000 illustrated in FIG. 10.

FIG. 10 illustrates an example of a computer in which a program is executed and accordingly the speech synthesis apparatus 100 is implemented. The computer 1000, for example, includes a memory 1010 and a CPU 1020. The computer 1000 includes a hard disk drive interface 1030, a disk drive interface 1040, a serial port interface 1050, a video adapter 1060, and a network interface 1070. Each of these units is connected via a bus 1080.

The memory 1010 includes a ROM (Read Only Memory) 1011 and a RAM 1012. The ROM 1011, for example, stores a boot program, such as a BIOS (Basic Input Output System). The hard disk drive interface 1030 is connected to a hard disk drive 1090. The disk drive interface 1040 is connected to a disk drive 1100. For example, a detachable recording medium, such as a magnetic disk or an optical disk, is inserted into the disk drive 1100. The serial port interface 1050, for example, is connected to a mouse 1110 and a keyboard 1120. The video adapter 1060, for example, is connected to a display 1130.

The hard disk drive 1090, for example, stores an OS 1091, an application program 1092, a program module 1093, and program data 1094. In other words, the program that defined each process of the speech synthesis apparatus 100 is implemented as the program module 1093 in which codes executable by the computer 1000 are written. The program module 1093 for executing the same processes as those of the functional configuration in the speech synthesis apparatus 100 is stored in the hard disk drive 1090. The hard disk drive 1090 may be replaced by a SSD (Solid State Drive).

The hard disk drive 1090 is able to store a speech synthesis program for the speech synthesis process. The speech synthesis program can be created as a program product. When executed, the program product executes one or a plurality of methods like those described above.

Setting data that is used in the process of the above-described embodiment is stored in, for example, the memory 1010 and the hard disk drive 1090 as the program data 1094. The CPU 1020 reads the program module 1093 and the program data 1094 that are stored in the memory 1010 and the hard disk drive 1090 to the RAM 1012 as required and executes the program module 1093 and the program data 1094.

The program module 1093 and the program data 1094 are not limited to the case of being stored in the hard disk drive 1090, and the program module 1093 and the program data 1094, for example, may be stored in a detachable storage medium and may be read by the CPU 1020 via the disk drive 1100, or the like. Alternatively, the program module 1093 and the program data 1094 may be stored in another computer that is connected via a network (such as a LAN or a WAN). The program module 1093 and the program data 1094 may be read from another computer by the CPU 1020 via the network interface 1070.

### 9. Summary of Embodiment

As described above, the speech synthesis apparatus 100 according to the disclosure includes the speech data obtainer 121, the utterance information obtainer 122, the book information obtainer 123, and the model trainer 126. In at least one embodiment, the utterance information obtainer 122 obtains utterance information on a subject to be uttered that is text contained in a first book, the book information obtainer 123 obtains image information on an image that is contained in the first book, and the speech data obtainer 121 obtains speech data corresponding to the subject to be uttered. In at least one embodiment, based on the utterance information that is obtained by the utterance information obtainer 122, the image information that is obtained by the book information obtainer 123, and the speech data that is obtained by the speech data obtainer 121, the model trainer 126 generates a speech synthesis model for reading out a second book that contains text that is associated with an image.

In some embodiments, the book information obtainer 123 obtains, as the image information, information on an image that is contained in a specific page of the first book and that is associated with text contained in the specific page.

In some embodiments, the speech data obtainer 121 obtains, as the speech data, data of speech of reading out the text that is contained in the specific page of the first book and that is associated with the image contained in the specific page.

In some embodiments, the utterance information obtainer 122 obtains the utterance information presenting at least one of accents, parts of speech, and a time of start of a phonome or a time of end of a phonome of the subject to be uttered.

As described above, the speech synthesis apparatus 100 according to the disclosure includes the vector representation acquirer 124 and the visual feature extractor 125. In at least one embodiment, the vector representation acquirer 124 converts the utterance information into a language vector representing linguistic information on the subject to be uttered. In at least one embodiment, the visual feature extractor 125 converts image information into a visual feature vector representing a visual feature of the image contained in the first book. In some embodiments, the model trainer 126 generates the speech synthesis model using training data containing the speech data that is associated with the language vector and the visual feature vector.

The various embodiments have been described in detail with reference to the accompanying drawings; however, the embodiments are examples and are not intended to limit the present invention to the embodiments. The features described in the description can be realized by various methods including various modifications and improvements based on the knowledge of those skilled in the art.

Note that the above-described “units (modules, -er suffixes, and -or suffixes)” are read as units, means, circuitry, or the like. For example, a communication unit (communication module), a control unit (control module), and a storage unit (storage module) can be read as a communication unit, a control unit, and a storage unit, respectively. Each control unit (for example, the model trainer (model learner)) can be also read as a model trainer.

### REFERENCE SIGNS LIST

1 Environment
100 Speech Synthesis Apparatus
110 Communication Unit
120 Control Unit
121 Speech Data Obtainer
122 Utterance Information Obtainer
123 Book Information Obtainer
124 Vector Representation Acquirer
125 Visual Feature Extractor
126 Model Trainer
127 Speech Synthesizer
130 Storage Unit
131 Speech Data
132 Utterance Information
133 Book Information
134 Speech Synthesis Model
200 Network
300 User Device

1. A speech synthesis apparatus comprising:
a memory; and
a processor coupled to the memory and configured to:
obtain utterance information on subjects to be uttered, wherein the subjects to be uttered are texts contained in data on a book,
obtain image information on images that M contained in the data on the book,
obtain speech data corresponding to the subjects to be uttered; and
generate, based on the obtained utterance information, the obtained image information, and the obtained speech data, speech synthesis model for reading out a text associated with an image.

2. The speech synthesis apparatus of claim 1, wherein the processor configured to obtain, as the image information, information on an image that is contained in a specific page of the first book and that is associated with a text contained in the specific page.

3. The speech synthesis apparatus of claim 1, wherein the processor configured to obtain, as the speech data, data of speech reading out a text that is contained in a specific page of the first book and that is associated with an image contained in the specific page.

4. The speech synthesis apparatus of claim 1, wherein the processor configured to obtain the utterance information presenting at least one of accents, parts of speech, and a time of start of a phonome or a time of end of a phonome of each of the subjects to be uttered.

5. The speech synthesis apparatus of claim 1, wherein the processor further configured to:
convert the utterance information into language vectors, wherein each language vector represents linguistic information on the corresponding subject to be uttered;
convert the image information into visual feature vectors, wherein each visual feature vector represents a visual feature of the corresponding image contained in the first book; and
generate the speech synthesis model using training data containing the speech data that is associated with the language vectors and the visual feature vectors.

6. A speech synthesis method performed by a computer, the method comprising:
obtaining utterance information on subjects to be uttered, wherein the subjects to be uttered is-text are texts contained in data on a book,
obtaining image information on images that are contained in the data on the book,
obtaining speech data corresponding to the subjects to be uttered; and
generating, based on the obtained utterance information, the obtained image information, and the obtained speech data, a speech synthesis model for reading out a text associated with an image.

7. A non-transitory computer readable storage medium having a speech synthesis program stored thereon that, when executed by a processor, causes the processor to perform operations comprising:
obtaining acquiring utterance information on subjects to be uttered, wherein the subjects to be uttered is-text are texts contained in data on a book,
obtaining image information on images that are contained in the data on the book,
obtaining speech data corresponding to the subjects to be uttered; and
generating, based on the obtained utterance information, the obtained image information, and the obtained speech data, a speech synthesis model for reading out a text associated with an image.

8. A speech synthesis apparatus comprising:
a memory; and
a processor coupled to the memory and configured to:
obtain utterance information on a subject to be uttered, wherein the subject to be uttered is a text contained in data on a book;
obtain image information on an image, wherein the image information corresponds to the text contained in the data on the book;
acquire a synthesized speech corresponding to the subject to be uttered by inputting the obtained utterance information and the obtained image information to a speech synthesis model for reading out a text that is associated with an image.
